(19) United States
(12) Patent Application Publication
(10) Pub. No.: US 2026/0317543 A1
(43) Pub. Date: Oct. 15, 2026

(54) STABILIZERS FOR BITUMINOUS COMPOSITIONS

(71) Applicant: ARKEMA FRANCE, Puteaux (FR)

(72) Inventors: Clémentine Champagne, Pierre-Bénite (FR); Lise DEVES, Pierre-Bénite (FR)

(21) Appl. No.: 19/478,113

(22) PCT Filed: Apr. 22, 2024
(86) PCT No.: PCT/FR2024/050523

§ 371 Date: Oct. 23, 2025

(30) Foreign Application Priority Data
Apr. 24, 2023 (FR) FR2304071

(51) Int. Cl. C08L 95/00

(52) U.S. Cl. CPC C08L 95/005; C08L 2555/80; C08L 2666/08

(57) ABSTRACT

The present invention relates to the use of a crosslinked cationic polymer, and preferably a crosslinked acrylic polymer, as stabilizing agent in a bituminous composition, preferably in a bituminous emulsion.

The invention also relates to a composition comprising at least bitumen and a crosslinked cationic polymer, preferably a crosslinked acrylic polymer.

### CROSS REFERENCES TO RELATED APPLICATIONS

This application is a national-stage application under 35 U.S.C. § 371 of International Application No. PCT/FR2024/050523, filed Apr. 22, 2024, which International Application claims benefit of priority to French Patent Application No. 2304071, filed Apr. 24, 2023, the entire contents of both of which are hereby incorporated by reference.

### FIELD OF THE INVENTION

The invention relates to the field of bituminous coatings, infrastructures, tarmacs or asphalts, and more particularly to the field of bitumen emulsions. More particularly, the invention relates to additives which are present in the bituminous coatings and are intended to stabilize and more specifically to limit or even prevent sedimentation and/or creaming of particles present in the bituminous compositions, typically bituminous emulsions.

### DESCRIPTION OF THE INVENTION

These sedimentation and creaming phenomena are well known today, with sedimentation being the phenomenon most often observed, especially in bituminous emulsions. Means of remedying this are also known, and most of them essentially involve incorporating into these bitumen emulsions one or more agents for modifying the rheology and so preventing destabilization of the emulsion during storage, especially by preventing sedimentation and/or by preventing creaming of the latter. These rheological agents are generally referred to as “anti-sedimentation agents” and “anti-creaming agents” by those skilled in the art.

The anti-sedimentation agents commonly used today in these applications are most often polymers, including especially rheological polymers or agents, such as plant gums or gums obtained by biological fermentation, more particularly xanthan gums or scleroglucans, which are described for example in document WO199106606 or else in document U.S. Pat. No. 6,451,885. These polymers are usually in the form of a powder or a dispersion in a solvent.

Other rheological agents are also sometimes used, but do not actually have an anti-sedimentation and/or anti-creaming effect, and they are referred to in these cases as “thickening agents”. Examples of such thickening agents are polyurethane thickeners, described for example in EP0534039, or else celluloses, as described in WO200004096, U.S. Pat. Nos. 4,492,781 and 6,451,885. As thickening agents it is also possible to find non-crosslinked cationic polymers, as described for example in documents U.S. Pat. Nos. 4,393,155, 4,772,647 and WO200100734. There are still other solutions, and one of the most commonly used solutions today is simply to add a salt, for example sodium or potassium chloride, to the solution.

Not all of these solutions, though, are entirely satisfactory. Indeed, problems remain today with each of these existing solutions, including, for example, the stabilization of bitumen emulsions during storage, a problem which remains not yet very well resolved. One potential solution could be to increase the bitumen content. Another solution could be to increase the amount of emulsifier so as to reduce the particle size. However, these two proposals suffer from the major drawback of the substantial additional cost generated by the increase in the amounts of bitumen and/or emulsifier used.

The addition of thickening agents to delay destabilization could also be considered. However, these agents do not completely avert destabilization. In addition, most of the thickeners which could be used are in solid form or else in the form of viscous liquids, which makes them difficult to handle, to meter and to incorporate into bituminous compositions.

Further proposed solutions employ anti-sedimentation agents to prevent or at least limit destabilization, but these agents prove difficult to handle, because they are either in powder form or in the form of a dispersion in a solvent, hence usually necessitating a redispersion step before use.

The aim of the present invention is to overcome the shortcomings of the solutions proposed in the prior art, and to propose stable or improved-stability bitumen emulsions, and most particularly bitumen emulsions which form little or no sediment over time and/or which exhibit little or no creaming effect over time. The inventors have now found that these aims are achievable, entirely or at least in part, by virtue of the present invention. Further aims will emerge in the course of the following description of the invention.

In the present description of the invention, it should be understood that all the percentages and quantities in ppm are given by weight and that all the ranges of values “between . . . and . . . ” and “from . . . to . . . ” are understood with endpoints included, unless otherwise stated.

Accordingly, a first subject of the invention relates to the use of a crosslinked cationic polymer, and preferably a crosslinked acrylic polymer, as an anti-sedimentation and/or anti-creaming agent in a bituminous composition.

In the present invention, the term “bituminous composition” is understood to mean any composition comprising at least one bitumen, optionally but preferably water, optionally mineral particles, and optionally one or more other additives well known to those skilled in the art and specialized in bituminous compositions. More particularly, the bituminous composition in the present invention is selected from bitumens, asphalts, hot asphalts, warm asphalts, cold pour asphalts, bituminous emulsions, and others, without this list being limiting in nature. Preferably, the bituminous composition is a bituminous emulsion.

The bitumens used in the bituminous compositions of the present invention may be of any type well known to those skilled in the art, and in particular those types selected from naphthenic bitumens, paraffinic bitumens, fluxed bitumens and other optionally modified, oxidized, recycled, synthetic or natural bitumens, and also mixtures of two or more thereof.

The present invention thus relates to the use of at least one crosslinked cationic polymer used as a stabilizer for a bituminous composition, and more specifically as an anti-sedimentation agent and/or anti-creaming agent for a bituminous composition. Among the crosslinked cationic polymers, preference is given to those which are in liquid form, and more preferably whose viscosity makes them easy to handle, and in particular pumpable to facilitate their metering and/or their incorporation into the bituminous compositions.

The crosslinked cationic polymers which can be used in the context of the present invention are homopolymers or copolymers obtained by homopolymerization or copolymerization of at least one monomer bearing on the one hand a cationic function, that is to say a function which is cationic or capable of forming a cation, for example and preferably an amine function, and on the other hand a polymerizable function, and preferably a vinyl function, for example and preferably selected from vinyl, allyl, acryloyl, acrylamido, methacryloyl and methacrylamido functions.

The crosslinked cationic polymers which can be used in the context of the present invention are well known to those skilled in the art or are easily prepared using known operating methods available in the scientific literature and on the Internet.

According to a very particularly preferred aspect, the crosslinked cationic polymers which can be used in the context of the present invention are homopolymers or copolymers obtained by homopolymerization or copolymerization respectively of at least one monomer bearing on the one hand a pendent cationic function, for example and preferably a pendent amine function, and on the other hand a polymerizable function, and preferably a vinyl function, for example and preferably selected from vinyl, allyl, acryloyl, acrylamido, methacryloyl and methacrylamido functions. More preferably, the crosslinked cationic polymers which can be used in the context of the present invention do not have a cationic function in the polymer chain.

Thus, and according to one embodiment, the crosslinked cationic polymers which are very particularly useful as anti-sedimentation agents according to the present invention are selected from crosslinked homo- or copolymers obtained by polymerization of at least one cationic monomer, selected from vinyl-, allyl-, acryloyl-, acrylamido-, methacryloyl- and methacrylamido-functional monomers, or salts thereof, with optionally one or more nonionic or anionic monomers, optionally in the presence of a transfer agent, and then or simultaneously, preferably simultaneously, crosslinking by means of at least one crosslinking agent.

These crosslinked cationic polymers have proven very particularly effective as anti-sedimentation agents in bituminous compositions, and in particular in bitumen emulsions. These same crosslinked cationic polymers have also proven, in certain cases, to be very particularly effective as anti-creaming agents in bituminous compositions, and in particular in bitumen emulsions.

These crosslinked cationic polymers (homopolymers or copolymers) are most often and generally obtained according to well-known polymerization processes known as “inverse emulsion polymerization” processes. Processes for obtaining such polymers are for example described in documents WO2005053748, U.S. Pat. No. 7,452,854, US20060094639 and U.S. Pat. No. 7,687,451.

More precisely, the crosslinked cationic polymers which can be used in the context of the present invention can advantageously be obtained by inverse emulsion polymerization of at least one water-soluble cationic monomer, preferably a water-soluble cationic monomer comprising at least one ethylenic unsaturation, as indicated above. The crosslinked cationic polymers which can be used in the context of the present invention may also comprise copolymers obtained by copolymerization, for example and preferably in inverse emulsion, of at least one water-soluble cationic monomer and at least one anionic and/or nonionic monomer.

As indicated above, these polymerizations and copolymerizations are carried out upstream or are carried out alone and advantageously and most often simultaneously with a crosslinking operation, as is well known in the technical field.

According to a preferred embodiment, the crosslinked cationic polymers which can be used in the context of the present invention can advantageously be obtained by inverse emulsion polymerization of:
a. at least one water-soluble cationic monomer, preferably a water-soluble ethylenically unsaturated cationic monomer, whose content is between 10% and 100%, relative to the mass composition (a)+(b)+(d), preferably between 25% and 100%,
b. at least one crosslinking agent whose content is between 2 ppm and 2000 ppm, relative to the mass composition (a)+(b)+(d), preferably between 5 ppm and 100 ppm, advantageously between 100 ppm and 500 ppm, better still between 500 ppm and 2000 ppm,
c. optionally between 0 and 50 000 ppm, relative to the mass composition (a)+(b)+(d), of at least one transfer agent, and
d. optionally q.s. of one or more anionic and/or nonionic monomers.

Non-limiting examples of monomers capable of forming the crosslinked cationic (co) polymers which can be used in the context of the present invention include dialkylaminoalkyl (meth)acrylates, dialkylaminoalkyl (meth)acrylamides, allylamine, methylallylamine, and their quaternary ammonium salts, and their acid salts.

Non-limiting examples of crosslinking agents capable of forming the crosslinked cationic (co)polymers which can be used in the context of the present invention include difunctional crosslinking agents, among which mention may be made of diallylamine, methyldiallylamine, divinylbenzene, tetraallylammonium chloride, allyl acrylates and methacrylates, diacrylates and dimethacrylates of glycols and polyglycols, butadiene, 1,7-octadiene, allylacrylamides, allylmethacrylamides, bisacrylamidoacetic acid, N,N′-methylenebisacrylamide, polyol polyallyl ether, diacrylamide, cyanomethyl acrylate, vinyloxyethyl acrylate and vinyloxyethyl methacrylate. Among the di(meth)acrylates, mention may be made, for example, of polyalkylene glycol di(meth)acrylates, in particular polypropylene glycol di(meth)acrylate, ethylene glycol di(meth)acrylate, polyethylene glycol di(meth)acrylate, triethylene glycol di(meth)acrylate, 1,3-butylene glycol di(meth)acrylate, 1,6-butylene glycol di(meth)acrylate, 1,6-hexanediol di(meth)acrylate, neopentyl glycol di(meth)acrylate, 1,9-nonanediol di(meth)acrylate, but also 2,2′-bis[4-(acryloxypropyloxyphenyl)]propane, 2,2′-bis[4-(acryloxydiethoxyphenyl)]propane and zinc acrylate.

Other examples of crosslinking agents include tri(meth)acrylates, such as trimethylolpropane tri(meth)acrylate (TMPTA), ethoxylated trimethylolpropane tri(meth)acrylate (such as, for example, TMPTA 3OE), trimethylolethane tri(meth)acrylate, pentaerythritol tri(meth)acrylate and tetramethylolmethane tri(meth)acrylate.

Yet other examples of crosslinking agents include tetra(meth)acrylate compounds such as ditrimethylolpropane tetra(meth)acrylate, tetramethylolmethane tetra(meth)acrylate, pentaerythritol tetra(meth)acrylate, hexa(meth)acrylate compounds such as dipentaerythritol hexa(meth)acrylate, penta(meth)acrylate compounds such as dipentaerythritol penta(meth)acrylate, allyl compounds such as allyl (meth)acrylate, diallyl phthalate, diallyl itaconate, diallyl fumarate, diallyl maleate, polyallyl ethers of sucrose having from 2 to 8 groups per molecule, polyallyl ethers of pentaerythritol such as pentaerythritol diallyl ether, pentaerythritol triallyl ether and pentaerythritol tetraallyl ether, polyallyl ethers of trimethylolpropane such as diallyltrimethylolpropane ether and triallyltrimethylolpropane ether. Yet other polyunsaturated compounds include divinyl glycol, divinylbenzene, divinylcyclohexyl, and methylenebisacrylamide.

Mixtures, in any proportions, of two or more of the abovementioned crosslinking agents may of course be used.

Among the transfer agents which may also be used, mention may be made, without any limitation, of malic acid, lactic acid, formic acid, isopropanol, sodium hypophosphite, mercaptans, such as, for example, butylmercaptan, n-octylmercaptan, n-dodecylmercaptan, tert-dodecylmercaptan, mercaptoethanol, and others.

Examples of nonionic monomers which may be copolymerized include, as non-limiting examples, acrylamide, methacrylamide, N-vinylpyrrolidone, vinyl acetate, vinyl alcohol, alkyl acrylates, alkyl methacrylates, (poly)alkylene glycol (meth)acrylates, allyl alcohol, and others, and also mixtures of two or more thereof.

Among the anionic monomers which may be copolymerized, mention may be made, in a non-exhaustive manner, of acrylic acid, methacrylic acid, maleic anhydride, itaconic acid, crotonic acid, monomers having a sulfonic acid function, for example 2-acrylamido-2-methylpropanesulfonic acid and salts thereof, and mixtures of two or more of the abovementioned anionic monomers.

The term “crosslinked acrylic polymer” is understood to mean a crosslinked cationic polymer chosen from those described above, which is derived from a homo- or copolymerization of at least one cationic monomer bearing at least one vinylcarbonyl function, for example a (meth)acryloyl or (meth)acrylamido function.

As indicated above, crosslinked cationic polymers are preferred, and among them crosslinked acrylic polymers which are obtained by inverse emulsion polymerization, and more preferably by inverse emulsion radical polymerization. In one preferred embodiment, the crosslinked cationic polymers which can be used in the context of the invention are in the form of a powder or dispersion in an aqueous phase, for example at a content of about 10% to 50% by weight of polymer relative to the total weight of the dispersion in an aqueous phase.

The crosslinked cationic polymers which can be used in the context of the present invention are generally known as additives in cosmetic, pharmaceutical, veterinary and detergent formulations, and most often in fabric softeners. According to yet another preferred embodiment, the preferred crosslinked cationic polymers are selected from cationic copolymers bearing one or more (meth)acrylate and (meth)acrylamide functions and crosslinked with a difunctional vinyl monomer, such as, for example, N,N′-methylenebisacrylamide.

More specifically, non-limiting examples of commercially available crosslinked cationic polymers include Flosoft® FS 222 marketed by SNF, or else Rheovis® FRC or else Rheovis® CDE, which are sold by BASF. These polymers, or similar polymers, are described, for example, in the aforementioned documents WO2005053748, U.S. Pat. No. 7,452,854, US20060094639 and U.S. Pat. No. 7,687,451.

It has been discovered, quite surprisingly, that the crosslinked cationic polymers known from the prior art exhibit stabilizing properties, and more particularly anti-sedimentation properties, in bituminous compositions, and in particular in bitumen emulsions, which are quite surprising. The anti-sedimentation properties of the crosslinked cationic polymers which can be used in the context of the present invention are measured in particular according to the standard NF EN 12847, “Determination of settling tendency of bitumen emulsions”, of July 2009.

The amount of crosslinked cationic polymers described above effective in the use of the present invention may vary in large proportions, depending on the nature of the bitumen, the bitumen content, and the nature of the other components used in the bituminous composition, but also depending on the applications envisaged. However, this amount is generally and most often between 0.01% and 10% relative to the total amount of the bituminous composition, and, according to a preferred aspect of the invention, the amount of crosslinked cationic polymers in the bitumen emulsion of the present invention is between 0.01% and 5%, more preferably between 0.01% and 3%, relative to the total amount of bituminous composition.

As indicated above, the bituminous composition may contain, in addition to the crosslinked cationic polymer(s) described above, one or more other additives, fillers and various compounds, well known to those skilled in the art, among which there may be mentioned, by way of non-limiting examples, surfactants, polymers, latices and mineral particles, such as aggregates, sand, and others.

Among the surfactants which may be present, mention may be made of surfactants and emulsifiers of any type, well known to those skilled in the art, and preferably cationic surfactants and mixtures of two or more of them, these mixtures preferably comprising at least one cationic surfactant, optionally in combination with one or more surfactants selected from nonionic and amphoteric surfactants or quaternary ammonium compounds.

According to one very particularly preferred embodiment, non-limiting examples of cationic surfactants include fatty polyamines, fatty amidoamines, fatty imidazolines, optionally in ethoxylated forms, especially compounds carrying hydrocarbon chains including from 6 to 30 carbon atoms. Among these compounds, particular mention may be made, for example, of Dinoram® S, Emulsamine® L60 or Dinoram® SLB, sold by Arkema, and also the Indulin® R33 and Indulin® R66 products sold by Ingevity, and the Redicote® 404 or Redicote® EM 22 products sold by Nouryon.

The bituminous composition may also comprise one or more other polymers, selected for example from elastomers, in the form of a latex in the emulsion or as a simple mixture in the bitumen, and preferably in the form of a latex. The latices are natural or synthetic elastomers, the natural latex being extracted from rubber trees, while the synthetic latex is derived from petrochemicals. Among synthetic latices, the most common is styrene-butadiene latex. When incorporated into bituminous compositions, latices make it possible to increase the elasticity of the asphalts to a significant extent, enabling them to meet more exacting stresses, particularly in terms of high traffic, extreme temperatures, and others.

According to yet another preferred aspect, the present invention relates to bituminous compositions which comprise a solvent. The term “solvent” means a solvent or a mixture of solvents selected from water and organic solvents. According to one particularly preferred aspect of the invention, the solvent is water. If necessary or desired, the use of one or more organic solvents alone or with water may be considered. Organic solvents which can be used in the bituminous compositions of the invention are those which are soluble in water and preferably insoluble or sparingly soluble with the bitumen included in said emulsion. Most particularly preferably, the solvent comprises water, and very advantageously the solvent is water.

The bituminous composition of the present invention generally, and most often, has a pH of between 1 and 3. This pH value can in particular be adjusted during the preparation of said composition by addition of acid, as is well known to those skilled in the art. The acids which can be used are inorganic or organic acids, preferably inorganic acids, selected in particular from hydrochloric acid and phosphoric acid, with hydrochloric acid being the acid most commonly and generally used in the technical field of bitumen emulsions.

The use according to the present invention is characterized in that at least one crosslinked cationic polymer, stabilizing agent, that is to say anti-sedimentation and/or anti-creaming agent, as has just been defined, is incorporated, according to any technique well known to those skilled in the art, for example into the bitumen or alternatively into the bituminous composition, using any suitable means, for example mixer, stirrer, simple pouring, and others.

According to another aspect, the present invention relates to a composition comprising at least bitumen and a crosslinked cationic polymer, preferably a crosslinked acrylic polymer. According to one preferred aspect, the composition of the invention comprises at least one bitumen, as defined above, and between 0.01% and 10% of one or more crosslinked cationic polymers as defined above, by weight relative to the total weight of said composition.

The composition of the invention may also comprise, as indicated above, one or more other additives, fillers and others, particularly surfactants, polymers, latices, solvents, and others.

In the bituminous composition of the present invention, said at least one crosslinked cationic polymer, and preferably said at least one cationic acrylic polymer, has anti-sedimentation and/or anti-creaming properties, meaning that it prevents or at least significantly slows down sedimentation and/or creaming respectively of components present in said bituminous composition, and in particular prevents or at least slows down the phase shift of bituminous compositions, and particularly when the bituminous compositions are bituminous emulsions.

Thus, and according to a further preferred aspect, the bitumen composition is a bitumen emulsion.

More specifically, the composition of the present invention is a bitumen emulsion comprising:
between 30% and 75% of bitumen,
between 0.01% and 10% of at least one crosslinked cationic polymer,
between 0.05% and 5% of at least one surfactant, preferably cationic, and
between 0% and 50% of latex,
optionally solvent q.s. 100%.

The bitumens used in the emulsion of the present invention may be of any type well known to those skilled in the art, as described above, and more particularly those types selected from naphthenic bitumens, paraffinic bitumens, fluxed bitumens and other optionally modified, oxidized, synthetic or natural bitumens, and also mixtures of two or more thereof.

The preferred crosslinked cationic polymers used as stabilizers and in particular as anti-sedimentation and/or anti-creaming agents in the bitumen emulsions of the present invention are those described above and which are advantageously in liquid form, and more preferably those whose viscosity makes them easy to handle, and in particular pumpable to facilitate their metering and/or their incorporation into bitumens.

It has been discovered, quite surprisingly, that on use in bituminous compositions and very particularly in bitumen emulsions, crosslinked cationic polymers known from the prior art exhibit quite surprising stabilization properties and very particularly anti-sedimentation properties and/or anti-creaming properties.

The amount of crosslinked cationic polymer(s) included in the emulsion of the present invention may vary in large proportions according to the nature of the bitumen, the bitumen content and the nature of the other components used in said emulsion, in particular according to the nature of the preferably cationic surfactant which acts as emulsifier.

As indicated above, the amount of crosslinked cationic polymer(s) d is between 0.01% and 10% relative to the total amount of bituminous composition, and in particular bituminous emulsion, and, according to a preferred aspect of the invention, the amount of crosslinked cationic polymer(s) in the bitumen composition of the present invention is between 0.01% and 5%, more preferably between 0.01% and 3%, relative to the total amount of emulsion.

As indicated above, the composition according to the invention has a pH of between 1 and 3, a pH which can be adjusted by addition of acid to said composition.

The bituminous composition of the invention, and in particular when it is a bitumen emulsion, may comprise one or more surfactants (or emulsifiers), as set out above, and preferably one or more cationic surfactant(s), and also optionally one or more latices, as described above.

The solvents optionally present in the bituminous composition of the invention are as described above, and preferably, when the bituminous composition is a bituminous emulsion, the solvent is water, or an organic solvent(s)/water mixture, and very advantageously the solvent is water.

The bituminous compositions of the present invention can be prepared according to any method well known to those skilled in the art and, for example, by simple mixing of the various components of said emulsion. It has been observed that the anti-sedimentation agent (the crosslinked cationic polymer) can be added both as a post-addition (after all other components) and to the “soap”, where the term soap denotes all water-soluble components, excluding in particular the bituminous phase.

Thus, and according to one embodiment, and in particular when the bituminous composition is a bituminous emulsion, the latter is prepared by first of all producing a “soap” by successive addition, with stirring, of the surfactant, the solvent, which is generally water, and then the crosslinked cationic polymer. According to some preferred embodiments, the solvent may be warmed before being added, to facilitate effective homogenization with the other components.

Similarly, and according to another variant, it may be advantageous, especially when the soap is cloudy, to adjust the pH, and most particularly to reduce the pH of the soap, ideally to a pH value of between 1 and 3, typically about 2, as indicated above. The bitumen emulsion is then produced by mixing the soap thus prepared with a bitumen with stirring, for example by means of a colloid mill.

According to another embodiment, for the composition of the invention, and in particular when the latter is a bituminous emulsion, the soap is prepared as described above, but without adding the crosslinked cationic polymer. The bitumen emulsion is produced with stirring, for example with a colloid mill, by adding the bitumen and the soap not containing the crosslinked cationic polymer. The crosslinked cationic polymer is then added, still with stirring, to the bitumen composition thus prepared.

The bituminous composition, and in particular the bitumen emulsion of the present invention, exhibits numerous advantages, among which mention may be made of very good stability, and in particular very good storage stability, measured according to standard NF EN 12847, that is to say at room temperature and for 7 days.

Moreover, the bituminous composition, and in particular the bitumen emulsion of the present invention, allows and guarantees good, or even very good, application performance qualities. In particular, the bitumen composition of the present invention does not result in a substantial modification to the breaking value, nor a substantial modification to the flow viscosity. Another not insignificant advantage of the bitumen composition of the present invention is an improvement in the adhesiveness of the bitumen, particularly on certain aggregates: in particular, but without any limitation, on aggregates of “acidic” nature, such as, for example and in a non-limiting manner, quartz, granites, some sandstones or diorites.

The following examples are given to illustrate the present invention and in no way limit the invention, the scope of protection thereof being conferred by the claims appended to the present description.

### EXAMPLES

The study performed aims to evaluate the effectiveness of the claimed solutions. The test and analytical methods used are described below.

The sedimentation tendency after seven days of storage is assessed according to the standard NF EN 12847 (July 2009), “Determination of settling tendency of bitumen emulsions”. The emulsions are placed in a 100 mL graduated cylinder. On conclusion of 7 days' storage at room temperature without agitation, the water content is determined on the upper 10 mL and the lower 10 mL. The emulsion is considered as stable if the difference in binder content between the two fractions is less than 10%.

The adhesiveness of the bitumen to the aggregate is determined according to a test adapted from the standard NF EN 13614 (June 2011), “Determination of the adhesiveness of bitumen emulsions by the water immersion test”. A washed and dried fraction of Vignat (quartz) 6/10 aggregates is coated. After an aging time of 16 hours to 24 hours at room temperature, the mixture is immersed in boiling water for 5 minutes. The percentage of bitumen remaining on the surface of the aggregates is evaluated according to the rating guide of the standard from which this test is derived.

The breaking value is measured according to the standard NF EN 13075-1, “Bitumens and bituminous binders—Determination of breaking behavior—Part 1: Determination of breaking value of cationic bitumen emulsions, mineral fines method” (September 2002).

The viscosity (in Pa·s) was measured with an Anton Paar MCR 501 rheometer equipped with a plane-plane geometry of 25 mm in diameter at an angular oscillation frequency of 10 rad/s, at a deformation amplitude of 1% and at a temperature of 25° C.

### Example 1: Addition of Anti-Sedimentation Agents to the Aqueous Phase, Improvement in Stability

Cationic bitumen emulsions with low bitumen contents are prepared, with the proportions indicated in Table 1 below. Levels of addition are given in kilograms (kg) for one ton of emulsion prepared.

Emulsion R1 is a reference emulsion containing no anti-sedimentation agent; emulsions E1 and E2 are emulsions according to the invention; the additive is added to the aqueous phase, called soap.

TABLE 1

| | | | |
|---|---|---|---|
| Emulsion | R1 | E1 | E2 |

Bituminous phase: 500 kg

| | | | |
|---|---|---|---|
| Bitumen 70/100 | 500 | 500 | 500 |
| Total Grandpuits | | | |

Aqueous phase: 500 kg

| | | | |
|---|---|---|---|
| Surfactant | Dinoram ® S⁽¹⁾ | Dinoram ® S⁽¹⁾ | Dinoram ® S⁽¹⁾ |
| | 2 | 2 | 2 |
| Acid | HCl | HCl | HCl |
| | 2.1 | 1.9 | 2 |
| Anti-sedimentation | — | Rheovis ® CDE⁽²⁾ | Flosoft FS 222⁽³⁾ |
| agent | 0 | 1 | 1 |
| Water | 495.9 | 495.1 | 495 |

⁽¹⁾Dinoram ® S is a cationic emulsifying surfactant, sold by Arkema,
⁽²⁾Rheovis ® CDE is a cationic acrylic polymer LDP, sold by BASF,
⁽³⁾Flosoft FS 222 is a cationic thickening polymer, sold by SNF.

All three emulsions are prepared according to an identical protocol with an Emulbitume automatic laboratory mill. The properties of the emulsions obtained are shown in Table 2 below:

TABLE 2

| Emulsion | R1 | E1 | E2 |
|---|---|---|---|
| pH of the aqueous phase⁽⁴⁾ | 2 | 2 | 2 |
| Homogeneity by sieving⁽⁵⁾ | 0 | 0.03 | 0.01 |
| Laser particle size - D50⁽⁶⁾ | 3.5 μm | 2.6 μm | 2.5 μm |
| Laser particle size - D90⁽⁷⁾ | 11.3 μm | 8.6 μm | 7.9 μm |
| Tendency toward sedimentation⁽⁸⁾ | 28.9 | 0.6 | 0.3 |

⁽⁴⁾according to standard NF EN 12850,
⁽⁵⁾reject material at 500 μm, according to standard NF EN 1429,
⁽⁶⁾particle size D50 measured with a laser particle size analyzer,
⁽⁷⁾particle size D90 measured with a laser particle size analyzer,
⁽⁸⁾after storage for 7 days, according to standard NF EN 12847.

This example shows a tendency toward sedimentation which is markedly lowered by using the additives of the invention, resulting in a very sharp improvement in the stability of the emulsion. The particle sizes are only very slightly modified (reduction in D50 and D90) and remain entirely acceptable for the applications envisaged.

### Example 2: Emulsion Stabilization by Addition of Anti-Sedimentation Agents in Accordance and not in Accordance with the Invention

Other cationic bitumen emulsions of spreading type are prepared. This second example makes it possible to compare the effect of adding the anti-sedimentation additives as described in the invention with a commercial additive not in accordance with the invention.

Emulsion R2 is another reference emulsion not containing an anti-sedimentation agent; emulsions E3 and E4 are emulsions according to the invention for which the additive is added to the soap. Emulsion EC1 is an emulsion produced with a commercial anti-sedimentation agent not in accordance with the invention, also added to the soap.

The proportions of the various components of the emulsions studied are presented in Table 3 below, where the levels of addition are expressed in kilograms (kg) for one ton of emulsion prepared.

TABLE 3

| | | | | |
|---|---|---|---|---|
| Emulsion | R2 | E3 | E4 | EC1 |

Bituminous phase: 650 kg

| | | | | |
|---|---|---|---|---|
| Bitumen 70/100 | 650 | 650 | 650 | 650 |
| Total Grandpuits | | | | |

Aqueous phase: 350 kg

| | | | | |
|---|---|---|---|---|
| Surfactant | Dinoram ® | Dinoram ® | Dinoram ® | Dinoram |
| | S83⁽⁹⁾ | S83⁽⁹⁾ | S83⁽⁹⁾ | S83⁽⁹⁾ |
| | 2 | 2 | 2 | 2 |
| Acid | HCl | HCl | HCl | HCl |
| | 1.9 | 2.7 | 2.8 | 1.8 |
| Anti- | — | Rheovis ® | Flosoft FS | Additive |
| sedimentation | | CDE⁽²⁾ | 222⁽³⁾ | V100⁽¹⁰⁾ |
| agent | 0 | 0.5 | 0.5 | 0.5 |
| Water | 346.1 | 344.8 | 344.7 | 345.7 |

⁽²⁾Rheovis ® CDE is a cationic acrylic polymer LDP, sold by BASF,
⁽³⁾Flosoft FS 222 is a cationic thickening polymer, sold by SNF,
⁽⁹⁾Dinoram ® S83 is a cationic emulsifying surfactant, sold by Arkema,
⁽¹⁰⁾Viscosity additive V100, sold by Arkema, is a gum-type rheological additive that improves storage stability.

The emulsions are all prepared according to an identical protocol with an Emulbitume automatic laboratory mill. The properties of the emulsions obtained are shown in Table 4 below:

TABLE 4

| Emulsion | R2 | | E3 | | E4 | | EC1 | |
|---|---|---|---|---|---|---|---|---|
| pH of the aqueous phase⁽⁴⁾ | 2 | | 1.5 | | 1.5 | | 2 | |
| Homogeneity by sieving⁽⁵⁾ | 0.04 | | 0.02 | | 0.03 | | 0.06 | |
| Viscosity (10 rad/s) | 0.5 | Pa · s | 0.6 | Pa · s | 0.85 | Pa · s | 8.5 | Pa · s |
| Laser particle size - D50⁽⁶⁾ | 5 | μm | 4.6 | μm | 4.6 | μm | 4.7 | μm |
| Laser particle size - D90⁽⁷⁾ | 16 | μm | 15 | μm | 14.7 | μm | 15.1 | μm |

| | | | | |
|---|---|---|---|---|
| Tendency toward | 14.6 | 2.33 | 1.67 | 0.04 |
| sedimentation⁽⁸⁾ | | | | |

⁽⁴⁾according to standard NF EN 12850,
⁽⁵⁾reject material at 500 μm, according to standard NF EN 1429,
⁽⁶⁾particle size D50 measured with a laser particle size analyzer,
⁽⁷⁾particle size D90 measured with a laser particle size analyzer,
⁽⁸⁾after storage for 7 days, according to standard NF EN 12847.

This example shows a very sharp improvement in the stability of the emulsion with the additives of the invention and with the commercial additive not in accordance with the invention (gum base).

Unlike the additive not in accordance with the invention, the additives as described in the invention also have the advantage of hardly modifying the viscosity of the emulsion, whereas the emulsion EC1 is 17 times more viscous than the reference emulsion. In addition, foam formation is observed for this emulsion, which is not acceptable from an industrial standpoint.

### Example 3: Comparison Between Addition to the Aqueous Phase and Post-Addition

Yet other cationic bitumen emulsions of spreading type are prepared. This example compares the effect of adding anti-sedimentation additives to the aqueous phase or of post-addition to the emulsion.

Cationic bitumen emulsions with low bitumen contents are prepared, with the proportions indicated in Table 5 below. Levels of addition are given in kilograms (kg) for one ton of emulsion prepared.

Emulsion R3 is a reference emulsion not containing an anti-sedimentation agent; emulsions E5 and E6 are emulsions according to the invention. For E5 the anti-sedimentation agent is added to the soap, while for E6 it is added as a post-addition to the emulsion.

TABLE 5

| | | | |
|---|---|---|---|
| Emulsion | R3 | E5 | E6 |

Bituminous phase: 630 kg

| | | | |
|---|---|---|---|
| Bitumen 70/100 | 500 | 500 | 500 |
| Total Grandpuits | | | |

Aqueous phase: 370 kg

| | | | |
|---|---|---|---|
| Surfactant | Dinoram ® | Dinoram ® | Dinoram ® |
| | S83⁽⁹⁾ | S83⁽⁹⁾ | S83⁽⁹⁾ |
| | 2 | 2 | 2 |
| Acid | HCl | HCl | HCl |
| | 1.8 | 1.9 | 1.8 |
| Anti- | — | Flosoft | Flosoft |
| sedimentation | | FS 222⁽³⁾ | FS 222⁽³⁾ |
| agent | | added to | added as post- |
| | | the soap | addition |
| | 0 | 0.5 | 0.5 |
| Water | 366.2 | 365.6 | 365.7 |

⁽³⁾Flosoft FS 222 is a cationic thickening polymer, sold by SNF,
⁽⁹⁾Dinoram ® S83 is a cationic emulsifying surfactant, sold by Arkema,

The emulsions are all prepared according to an identical protocol with an Emulbitume automatic laboratory mill. The properties of the emulsions obtained are shown in Table 6 below:

TABLE 6

| Emulsion | R3 | E5 | E6 |
|---|---|---|---|
| pH of the aqueous phase⁽⁴⁾ | 2 | 2 | 2 |
| Viscosity⁽¹¹⁾ | 7 s | 7 s | 9 s |
| Breaking value⁽¹²⁾ | 102 | 103 | 105 |
| Bitumen adhesiveness⁽¹³⁾ | 50 | 75 | 75 |

⁽⁴⁾according to standard NF EN 12850,
⁽¹¹⁾flow viscosity 4 mm at 40° C., according to standard NF EN 12846,
⁽¹²⁾measured according to standard NF EN 13075-1,
⁽¹³⁾adhesiveness of the bitumen to the aggregate measured according to the operating procedure adapted from standard NF EN 13614, as indicated above.

This example shows that the addition of the additive according to the invention, whether to the aqueous phase or as a post-addition, does not influence the breaking properties or the viscosity of the emulsion. These properties are of major importance for the use of bitumen emulsions as carried out in the example which are intended for spreading. In both cases (direct addition to the soap or post-addition), a clear improvement in the adhesiveness of the bitumen to the aggregate is noted in the presence of the additive as described in the invention.

1-10. (canceled)

11. A method of stabilizing a bituminous composition, the method comprising incorporating a crosslinked cationic polymer into the bituminous composition.

12. The method of claim 1, wherein the bituminous composition is selected from the group consisting of bitumens, asphalts, hot asphalts, warm asphalts, cold pour asphalts, and bituminous emulsions.

13. The method of claim 1, wherein the bituminous composition is a bituminous emulsion.

14. The method of claim 1, wherein the bituminous composition is selected from the group consisting of naphthenic bitumens, paraffinic bitumens, synthetic bitumens, modified synthetic bitumens, oxidized synthetic bitumens, recycled synthetic bitumens, natural bitumens, modified natural bitumens, oxidized natural bitumens, recycled natural bitumens, and combinations thereof.

15. The method of claim 1, wherein the crosslinked cationic polymer comprises a homopolymer or copolymer obtained by:
polymerizing monomers comprising at least one cationic monomer, optionally one or more nonionic monomers, and optionally one or more or anionic monomers, wherein the at least one cationic monomer is selected from the group consisting of vinyl-functional monomers, allyl-functional monomers, acryloyl-functional monomers, acrylamido-functional monomers, methacryloyl-functional monomers, methacrylamido-functional monomers, and salts thereof; and
crosslinking using at least one crosslinking agent.

16. The method of claim 15, wherein the polymerizing is performed in the presence of a transfer agent.

17. The method of claim 1, wherein the crosslinked cationic polymer is obtained by inverse emulsion polymerization of:
(a) at least one water-soluble cationic monomer;
(b) at least one crosslinking agent;
(c) optionally at least one transfer agent; and
(d) optionally q.s. of one or more anionic and/or one or more nonionic monomers, wherein:
an amount of the at least one water-soluble cationic monomer is at least 10% of a combined mass of (a), (b), and (d);
an amount of the at least one crosslinking agent relative to the combined mass of (a), (b), and (d) is from 2 ppm to 2000 ppm; and
an amount of the at least one transfer agent relative to the combined mass of (a), (b), and (d) is from 0 to 50,000 ppm.

18. The method of claim 17, wherein:
the at least one water-soluble cationic monomer is a water-soluble ethylenically unsaturated cationic monomer;
the amount of the at least one water-soluble cationic monomer is at least 25% of the combined mass of (a), (b), and (d).

19. The method of claim 17, wherein the amount of the at least one crosslinking agent relative to the combined mass of (a), (b), and (d) is from 5 ppm to 100 ppm.

20. The method of claim 17, wherein the amount of the at least one crosslinking agent relative to the combined mass of (a), (b), and (d) is from 100 ppm to 500 ppm.

21. The method of claim 17, wherein the amount of the at least one crosslinking agent relative to the combined mass of (a), (b), and (d) is from 500 ppm to 2000 ppm.

22. The method of claim 1, wherein an amount of the crosslinked cationic polymer incorporated into the bituminous composition is from 0.01% to 10% of the total amount by weight of the bituminous composition and the crosslinked cationic polymer.

23. The method of claim 1, wherein an amount of the crosslinked cationic polymer incorporated into the bituminous composition is from 0.01% to 5% of to the total amount by weight of the bituminous composition and the crosslinked cationic polymer.

24. The method of claim 1, wherein an amount of the crosslinked cationic polymer incorporated into the bituminous composition is from 0.01% to 3% of to the total amount by weight of the bituminous composition and the crosslinked cationic polymer.

25. A composition comprising bitumen and a crosslinked cationic polymer.

26. The composition of claim 25, wherein the crosslinked cationic polymer is a crosslinked acrylic polymer.

27. The composition of claim 25, wherein the composition is a bitumen emulsion.

28. The composition of claim 25, wherein an amount of the crosslinked cationic polymer in the composition is from 0.01% to 10% of to the total amount by weight of the composition.

29. The composition of claim 25, wherein the composition is a bitumen emulsion comprising:
from 30% to 75% of bitumen;
from 0.01% to 10% of at least one crosslinked cationic polymer;
from 0.05% to 5% of at least one surfactant;
from 0% to 50% of latex; and
optionally solvent q.s. to 100%.

30. The composition of claim 29, wherein the at least on surfactant comprises at least one cationic surfactant.
